(19) United States
(12) Patent Application Publication
(10) Pub. No.: US 2023/0365037 A1
(43) Pub. Date: Nov. 16, 2023

(54) HOT-MELT MAGNETIC TAPE, CLOTH-LIKE MATERIAL FOR FOAM MOLDING AND METHOD FOR PRODUCING THE SAME, METHOD FOR PRODUCING FOAM MOLDED COMPOSITE, AND VEHICLE SEAT

(71) Applicants: TOYO INK SC HOLDINGS CO., LTD., Tokyo (JP); TOYOCHEM CO., LTD., Tokyo (JP); MOLD TECHNICAL OFFICE CO., LTD., Kanagawa (JP)

(72) Inventors: Hideyuki ISHIGURO, Tokyo (JP); Kenichi HARA, Tokyo (JP); Hiroshi YAMAGUCHI, Tokyo (JP); Toshio IWASAWA, Kanagawa-ken (JP); Futoshi TAKAHASHI, Kanagawa-ken (JP); Ryo IWASAWA, Kanagawa-ken (JP)

(73) Assignees: TOYO INK SC HOLDINGS CO., LTD., Tokyo (JP); TOYOCHEM CO., LTD., Tokyo (JP); MOLD TECHNICAL OFFICE CO., LTD., Kanagawa (JP)

(21) Appl. No.: 18/196,124

(22) Filed: May 11, 2023

(30) Foreign Application Priority Data
May 13, 2022 (JP) 2022-079841

(51) Int. Cl. B60N 2/70; B29C 44/14; C09J 7/35; C09J 11/04; C09J 11/08; C09J 123/08; C09J 9/00

(52) U.S. Cl. CPC B60N 2/7017; B29C 44/143; C09J 7/35; C09J 11/04; C09J 11/08; C09J 123/0853; C09J 9/00; B29L 2031/58

(57) ABSTRACT

A hot-melt magnetic tape for a foam molded body, the tape having a magnetic layer formed from a hot-melt magnetic material, where the hot-melt magnetic material has a ring and ball softening point of 105° C. or more and 140° C. or less, and the hot-melt magnetic material includes: a thermoplastic resin containing an ethylene-vinyl acetate copolymer (A); and a magnetic powder (C), and, optionally, further includes a wax (B), where 20 to 80% by mass of the component (A), 0 to 8% by mass of the component (B), and 15 to 80% by mass of the component (C) are contained in 100% by mass in total of the component (A), component (B), and component (C), and a structural unit derived from a vinyl acetate monomer for the ethylene-vinyl acetate copolymer (A) accounts for 15 to 30% by mass.

### INCORPORATION BY REFERENCE

This application is based upon and claims the benefit of priority from Japanese patent application No. 2022-079841, filed on May 13, 2022, the disclosure of which is incorporated herein in its entirety by reference.

### BACKGROUND

The present disclosure relates to a hot-melt magnetic tape. The present disclosure also relates to a cloth-like material for foam molding and a method for producing the same. Furthermore, the present disclosure relates to a method for producing a foam molded composite and a vehicle seat.

A vehicle seat has a frame in which a spring is housed, and a cushion material is provided thereon. This cushion material has a foam molded body such as urethane foam and a cloth-like material for foam molding. This cloth-like material for foam molding is made of cheesecloth, nonwoven fabric or the like, and is placed on the side that contacts the spring in order to prevent deterioration of the foam molded body, prevent seepage, prevent abnormal noise due to contact with the spring, and so on.

Such a cushion material is produced through the steps of temporarily fixing a three-dimensionally molded cloth-like material for foam molding in a metal mold, then injecting foamed resin into the metal mold to form a foam molded body, and integrating this foam molded body with the cloth-like material for foam molding. Conventionally, three-dimensional molding of the cloth-like material for foam molding has been performed by cutting and sewing steps. However, there is known a method of setting a raw cloth-like material for foam molding in a mold and three-dimensionally processing and molding by heating (Japanese Unexamined Patent Application Publication No. 2006-281768 and Japanese Unexamined Patent Application Publication No. 2009-220445).

As a method for efficiently and temporarily fixing this three-dimensionally molded cloth-like material for foam molding to a metal mold, there is proposed a method of embedding a permanent magnet in a metal mold to temporarily and magnetically fix a cloth-like material for foam molding to which a hot-melt magnetic material is fixed at a predetermined position (Japanese Unexamined Patent Application Publication No. 2015-048544, Japanese Unexamined Patent Application Publication No. 2018-3199).

### SUMMARY

The method of temporarily and magnetically fixing the cloth-like material for foam molding to a metal mold has the advantage of allowing effective prevention of displacement and peeling of the cloth-like material for foam molding. However, there is a demand in the market for a cloth-like material for foam molding that is more productive.

The present disclosure has been made in view of the above circumstances, and an object of the present disclosure is to provide a hot-melt magnetic tape, a cloth-like material for foam molding, a method for producing the same, a method for producing a foam molded composite, and a vehicle seat, which are excellent in productivity.

The hot-melt magnetic tape and cloth-like material for foam molding of the present disclosure are suitable for use in a foam molded composite used for a seat for a vehicle or the like, but can be used for any application.

The present disclosure provides a hot-melt magnetic tape, a cloth-like material for foam molding and a method for producing the same, a method for producing a foam molded composite, and a vehicle seat, as described below.

[1]: A hot-melt magnetic tape for a foam molded body, the tape comprising a magnetic layer formed from a hot-melt magnetic material, wherein
(i) the hot-melt magnetic material has a ring and ball softening point of more than 100° C. and 150° C. or less, and
(ii) the hot-melt magnetic material includes: a thermoplastic resin containing an ethylene-vinyl acetate copolymer (A); and a magnetic powder (C), and optionally further includes a wax (B), wherein 20 to 80% by mass of the component (A), 0 to 8% by mass of the component (B), and 15 to 80% by mass of the component (C) are contained in 100% by mass in total of the component (A), component (B), and component (C).
   [2]: The hot-melt magnetic tape according to [1], wherein a saturation magnetization density of the hot-melt magnetic material is 20 to 400 emu/cm³.
   [3]: The hot-melt magnetic tape according to [1] or [2], wherein a structural unit derived from a vinyl acetate monomer for the ethylene-vinyl acetate copolymer (A) accounts for 12 to 45% by mass.
   [4]: A cloth-like material for foam molding, formed by impregnating and fixing a hot-melt magnetic material on a part of a surface of a nonwoven fabric, wherein
(i) the hot-melt magnetic material has a ring and ball softening point of more than 100° C. and 150° C. or less, and
(ii) the hot-melt magnetic material includes: a thermoplastic resin containing an ethylene-vinyl acetate copolymer (A); and a magnetic powder (C), and optionally further includes a wax (B), wherein 20 to 80% by mass of the component (A), 0 to 8% by mass of the component (B), and 15 to 80% by mass of the component (C) are contained in 100% by mass in total of the component (A), component (B), and component (C).
   [5]: The cloth-like material for foam molding according to [4], wherein a structural unit derived from a vinyl acetate monomer for the ethylene-vinyl acetate copolymer (A) accounts for 12 to 45% by mass.
   [6]: The cloth-like material for foam molding according to [4] or [5], wherein a melt flow rate of the hot-melt magnetic material at 190° C. and 21.168 N is 5 to 1000 g/10 minutes.
   [7]: A method for producing a cloth-like material for foam molding, the method comprising:

a fixing step of placing the hot-melt magnetic tape according to any one of [1] to [3] on a surface of a nonwoven fabric, and fixing the hot-melt magnetic tape at a desired position on the nonwoven fabric by a means for heating; and

a step of setting the nonwoven fabric to which the hot-melt magnetic tape is fixed in a mold, and processing and molding the nonwoven fabric three-dimensionally by a means for heating.

[8]: The method for producing a cloth-like material for foam molding according to [7], wherein

the hot-melt magnetic tape extends longitudinally,

the method further comprises a dividing step of dividing a fixed portion of the hot-melt magnetic tape to the nonwoven fabric by the fixing step and a non-fixed portion of the hot-melt magnetic tape, and

the fixing step and the dividing step are performed alternately to fix a hot-melt magnetic material at a desired position of the nonwoven fabric while dividing the hot-melt magnetic tape into each of the fixed portion.

[9]: The method for producing a cloth-like material for foam molding according to [7] or [8], wherein the means for heating is ultrasonic heating.
[10]: A method for producing a foam molded composite, the method comprising:

a step a of permeating a hot-melt magnetic material into a part of a surface of a nonwoven fabric by using a means for heating to obtain the cloth-like material for foam molding according to any one of [4] to [6];

a step b of temporarily and magnetically fixing the cloth-like material for foam molding to a mold surface of a mold;

a step c of integrating, after the step b, a foam molded body obtained by introducing a foamed resin into the mold and foaming, with the cloth-like material for foam molding to thereby obtain a foam molded composite; and

a step d of removing, after step c, the foam molded composite from the mold.

[11]: A vehicle seat comprising the cloth-like material for foam molding according to any one of [4] to [6].

The present disclosure exhibits an excellent effect of providing a hot-melt magnetic tape, a cloth-like material for foam molding and a method for producing the same, a method for producing a foam molded composite, and a vehicle seat, which are excellent in productivity.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic top view showing one example of the hot-melt magnetic tape according to an embodiment;

FIG. 2 is a sectional view taken along line II-II of FIG. 1;

FIG. 3 is a schematic top view showing one example of the hot-melt magnetic tape according to a modified example;

FIG. 4 is a sectional view taken along line Iv-Iv of FIG. 3;

FIG. 5 is a partially enlarged cross-sectional view showing one example of the cloth-like material for foam molding according to the embodiment; and

FIG. 6 is a schematic perspective view showing one example of the cloth-like material for foam molding according to the embodiment.

### DETAILED DESCRIPTION OF EMBODIMENTS

The present disclosure will be described in detail below. Other embodiments are also included in the scope of the present disclosure as long as they are consistent with the gist of the present disclosure. In addition, in the present description, the numerical range specified using “to” includes the numerical values described before and after “to” as the range of lower and upper values. In addition, in the present description, the terms “film”, “sheet”, and “tape” have the same meaning and are not distinguished by thickness or shape. In addition, various components appearing in the present description may be each independently used singly or in combination of two or more, unless otherwise specified.

As used in the present description, the “ring and ball softening point” means a temperature measured according to JIS K 6863. Furthermore, the term “foam molded body” refers to a foamed body made of a predetermined resin. The foam shape is not particularly limited, and spherical bubbles, substantially spherical bubbles, and tear-shaped bubbles can be exemplified. Each cell may be partially connected. The term “thermoplastic resin” refers to a resin that can be melt-molded by heating. The term “hot-melt” refers to the property of being in a solid or viscous state at room temperature and being melted by heating to become a softening, fluid, or liquid state. In addition, the term “melt flow rate” (hereinafter also referred to as MFR) is one of the scales showing the fluidity of a resin in a molten state, and is a value measured under conditions of 190° C. and 21.168 N in accordance with JIS K7210.

### 1. Hot-Melt Magnetic Material

The hot-melt magnetic material of the present disclosure (hereinafter also referred to as the present magnetic material) is a hot-melt adhesive having a ring and ball softening point (hereinafter also referred to as softening point) of more than 100° C. and 150° C. or less. This present magnetic material is solid at room temperature, but softens or liquefies when heated, and has the property of being flowable, and has magnetism that attracts a magnet. However, the magnetic material may become non-magnetic due to oxidation or the like, after being used for applications requiring magnetic force.

The present magnetic material includes a thermoplastic resin containing an ethylene-vinyl acetate copolymer (A) (hereinafter also referred to as component (A)) and magnetic powder (C) (hereinafter also referred to as component (C)). The ethylene-vinyl acetate copolymer (A) is a copolymer obtained by copolymerizing an ethylene monomer and a vinyl acetate monomer. The ethylene-vinyl acetate copolymer (A) can be a random copolymer, a block copolymer, or an alternating copolymer.

Wax (B) (hereinafter also referred to as component (B)) may be added as a blending component of the present magnetic material. The present magnetic material contains 20 to 80% by mass of the component (A), 0 to 8% by mass of the component (B), and 15 to 80% by mass of the component (C) in 100% by mass in total of the component (A), component (B), and component (C). Setting the component (A) to 20 to 80% by mass can maintain good fixability to a magnet while maintaining good processability (moldability). Setting the component (B) to 8% by mass or less can maintain good mold followability. In addition, setting the component (C) to 15 to 80% by mass can maintain good mold followability, separability, and processability, which will be described later, while maintaining good fixability to the magnet.

The present magnetic material can significantly improve productivity. The main reason is that setting the softening point to more than 100° C. and 150° C. or less, and blending the combination of the component (A), component (B), and component (C) in the above ratio can increase the degree of freedom in designing the production process for fixing the present magnetic material. Setting more than 100° C. can perform a heating process including steam heating. Whereas, setting 150° C. or less can make the meltability moderate and make the separability excellent in the hot-melt magnetic material tape described later. A more preferable softening point range is 105 to 140° C., and a further preferable range is 110 to 140° C. Adjusting the vinyl acetate amount of the ethylene-vinyl acetate copolymer and the MFR of the ethylene-vinyl acetate copolymer in the present magnetic material can adjust the softening point.

From the viewpoint of obtaining excellent separability and adhesion of the hot-melt magnetic tape, the proportion of the structural unit derived from the vinyl acetate monomer in the ethylene-vinyl acetate copolymer (A) is preferably 12 to 45% by mass. Setting this range can maintain a balance among the followability, separability, and weldability (adhesion) of the hot-melt magnetic material to an adherend such as a nonwoven fabric. A more preferable range of the proportion of the structural unit derived from the vinyl acetate monomer in the ethylene-vinyl acetate copolymer (A) is 15 to 30% by mass.

The ethylene-vinyl acetate copolymer (A) may include the monomer other than the ethylene monomer and vinyl acetate monomer within a range that does not impair the properties of the present disclosure.

The total content of the component (A), component (B), and component (C) is preferably 60 to 100% by mass based on 100% by mass of the present magnetic material. Setting this range can exhibit adhesiveness and separability more effectively. A more preferable range is 70 to 100% by mass, and a further preferable range is 80 to 100% by mass.

The MFR of the ethylene-vinyl acetate copolymer (A) is, for example, 0.1 g/10 minutes or more and 1000 g/10 minutes or less. The MFR is preferably 1 g/10 minutes or more and 500 g/10 minutes or less, more preferably 3 g/10 minutes or more and 400 g/10 minutes or less. MFR is the amount of outflow (g/10 minutes) for 10 minutes at 190° C. and a load of 21.168 N, measured according to JIS K7210.

The magnetic powder (C) is a powder having magnetism that attracts a magnet, and preferable examples include powdery magnetic materials exhibiting soft magnetic materials such as iron, silicon iron, permalloy, soft ferrite, sendust, permendur, electromagnetic stainless steel, amorphous, and nanocrystals.

The type of magnetic powder (C) may be appropriately designed according to the required magnetic force. The magnetic powder may have a magnetic force capable of being temporarily fixed to the mold when used for a cloth-like material for foam molding, which will be described later. In the case of a cloth-like material for foam molding, which will be described later, the cloth-like material for foam molding may has a magnetic force capable of preventing wrinkles, sagging, and displacement. For example, a saturation magnetization density of the present magnetic material can be set to 20 to 400 emu/cm³. Setting this range can achieve both the fixability to a magnet and the followability to a mold. The saturation magnetization density can be adjusted by the type and content of the magnetic powder.

The average particle size of the magnetic powder (C) can be designed depending on the application. For example, 1 to 500 μm can be possible. Setting this range can improve homogeneity and impregnation and maintain an appropriate sedimentation rate of the magnetic powder (C) when permeating into the nonwoven fabric while maintaining good dispersibility of the present magnetic material. A more preferable range for the average particle size of the magnetic powder (C) is 15 to 100 μm.

The wax (B) plays a role of improving fluidity and heat resistance of the present magnetic material. Specific examples of the wax (B) include carnauba wax, candelilla wax, montan wax, paraffin wax, microwax, Fischer-Tropsch wax, polyethylene wax, polypropylene wax, or oxides of these waxes. In addition, examples thereof include ethylene-acrylic acid copolymer wax and ethylene-methacrylic acid copolymer wax. The wax (B) is used singly or in combination of two or more. Fischer-Tropsch wax, polyethylene wax, and polypropylene wax are particularly preferable.

Preferable examples of the wax (B) include a low viscosity material with a molecular weight of 300 to 10,000, the MFR thereof in accordance with JIS K7210 being unmeasurable. The kinematic viscosity (JIS K2283) of the wax (B) is preferably 30 mm²/s or less, more preferably 20 mm²/s or less, and further preferably 10 mm²/s or less.

The melting point of the wax (B) is, for example, 70 to 160° C., and from the viewpoint of optimizing the softening point of the hot-melt magnetic material, the melting point is preferably 80 to 150° C., more preferably 90 to 140° C., further preferably 100 to 130° C. The melting point is the temperature measured by the DSC method.

The MFR of the present magnetic material at 190° C. and 21.168 N is preferably 5 to 1000 g/10 minutes. Combining the above-described softening point within the specific range with the MFR can more effectively improve the impregnation of the cloth-like material for foam molding. In addition, productivity can be remarkably improved in the production of a cloth-like material for foam molding, which will be described later. A more preferable range of MFR is 10 to 300 g/10 minutes, and further preferably 10 to 100 g/10 minutes. Adjusting the required amount of vinyl acetate of the ethylene-vinyl acetate copolymer (A) and the MFR of vinyl acetate of the ethylene-vinyl acetate copolymer (A) in the present magnetic material can adjust the MFR of the present magnetic material.

A thermoplastic resin other than the ethylene-vinyl acetate copolymer (A) can be used for the present magnetic material. In addition, the present magnetic material may be mixed with another additive within the scope of the present disclosure in order to improve the dispersibility and fluidity of the magnetic powder (C). Examples of another additive include a mineral oil softener, a glass filler, a silica fiber, and a liquid paraffin. The thermoplastic resin other than the ethylene-vinyl acetate copolymer (A) and another additive can be mixed in a total amount of preferably 40% by mass or less based on 100% by mass of the present magnetic material.

### 2. Method for Producing Hot-Melt Magnetic Material

The hot-melt magnetic material of the present disclosure can be prepared, for example, by mixing and dispersing the magnetic powder (C) in a melted thermoplastic resin and, if necessary, a melted wax (B) in a melter equipped with a stirrer. In addition, the present magnetic material may be produced by mixing and dispersing a blending component in an extruder and extruding the melted mixture through a nozzle at the tip of the extruder.

There may be used the present magnetic material obtained by mixing the blending component and molding into a desired shape. Examples of the desired shape include a granular shape, a pellet shape, a plane shape, and a block shape. As these methods, known methods can be used without limitation.

Specific examples of the plane shape include a sheet shape, a net shape, and a cloth shape. Examples of the method for forming the sheet shape include a method for forming a magnetic layer on a release sheet by a T-die method. A known method can be applied in addition to the T-die method. Examples of the method for forming a long sheet shape (tape shape) include a method for dividing the sheet into long pieces and winding them up.

The present magnetic material is melted and fluidized by a means for heating such as heat, ultrasonic wave, and electromagnetic induction heating, and thus can be impregnated into an adherend or coated on an adherend by a means for heating. It is easy to mold into a desired shape by using a mold during cooling, and thus a magnetic material having a desired shape can be fixed at a target position of an adherend such as a nonwoven fabric. Examples of the adherend include various fibers such as nonwoven fabric and cheesecloth; prepreg such as carbon fiber; and various plastic sheets such as polyethylene.

The present magnetic material can be suitably used as a hot-melt magnetic tape having a magnetic layer formed from the present magnetic material. In addition, the present magnetic material can be suitably used for producing a cloth-like material for foam molding in which the present magnetic material is impregnated on nonwoven fabric.

### 3. Hot-Melt Magnetic Tape

The hot-melt magnetic tape of the present disclosure (hereinafter also referred to as the present magnetic tape) has a layer formed from the present magnetic material described above.

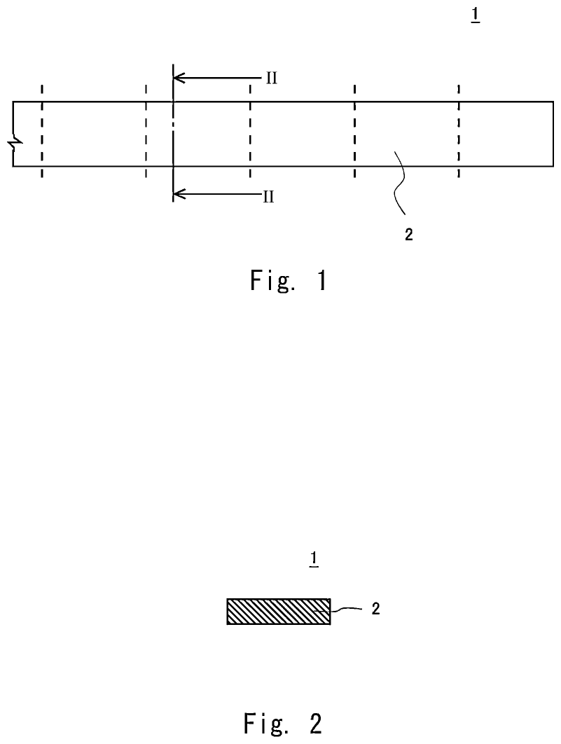

FIG. 1 shows a schematic plan view showing an example of the present magnetic tape, and FIG. 2 shows a cross-sectional view taken along the line II-II of FIG. 1. A magnetic tape 1 has a magnetic layer 2 formed from a hot-melt magnetic material. The thickness of the magnetic layer 2 can be set to, for example, 50 to 3000 μm. Setting this range improves the adhesiveness to a magnet and the processability of the tape. The thickness is more preferably 100 to 1000 μm, and further preferably 300 to 500 μm. The width in the lateral direction may be optionally designed according to the application, and can be set to, for example, 5 to 50 mm.

The magnetic tape 1 extends in the longitudinal direction as shown in FIG. 1, and can be used by being divided at an optional position in the longitudinal direction of the magnetic tape 1, for example, at a position indicated by dotted lines in FIG. 1, like cellophane tape. The present magnetic tape may be laminated with a release layer and a protective layer before use. In addition, the magnetic tape may be composed of a laminate having two or more layers of the magnetic layer. In the case of the laminate, at least one magnetic layer is formed from the hot-melt magnetic material of the present disclosure. Furthermore, the present magnetic tape may be a laminate having a hot-melt magnetic layer and a hot-melt non-magnetic layer.

The present magnetic tape can be applied to various uses. The magnetic tape can be used for impregnation, coating, and lamination on an adherend. In particular, the magnetic tape is suitable for various uses, including uses for foam molded bodies such as a cloth-like material for foam molding and a foam molded composite, which will be described later. The cloth-like material for foam molding is a cloth-like material in which a hot-melt magnetic material is permeated and fixed on a portion of the surface of a nonwoven fabric. In the case of use of the cloth-like material for foam molding, the ratio of the thickness of the magnetic layer when the thickness of the cloth-like material is 1 can be set to, for example, 0.01 to 2. The thickness ratio of the magnetic layer is more preferably 0.03 to 1, further preferably 0.05 to 1.

Conventionally, there has been used a production method including liquefying a hot-melt magnetic material by heating and then stamping onto an adherend such as nonwoven fabric. According to the present magnetic tape, the magnetic tape can be placed on the surface of an adherend such as nonwoven fabric, and the magnetic tape can be easily fixed by a means for heating. In addition, in the present magnetic layer, the magnetic tape on the non-fixed portion, which is the non-heated portion, is lightly pulled in the direction of pulling away, thereby allowing to easily divide the non-fixed portion from the fixed portion that has been subjected to permeation by heating and melting and fixed by cooling.

### MODIFIED EXAMPLE

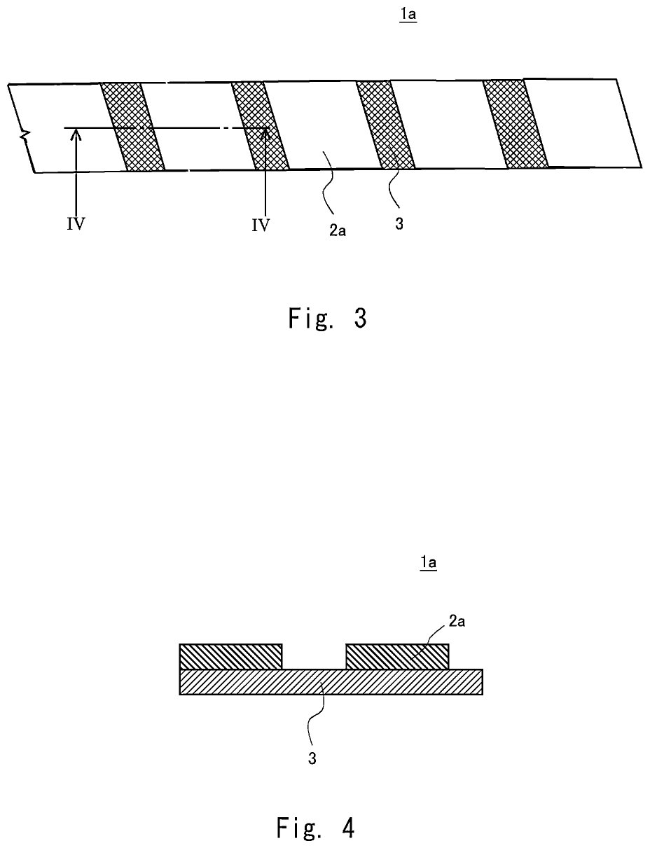

In the present magnetic tape, as shown in FIGS. 3 and 4, a magnetic layer 2a may be formed on a release layer 3 at predetermined intervals. This method can easily fix a magnetic layer having a desired shape to an adherend. In addition to the long magnetic tape shown in FIG. 1, the magnetic tape can be made into a sheet having an optional length-to-width ratio. In addition, it is possible to freely design a desired shape, such as a circular shape, according to the shape of the object to be adhered.

### 4. Method for Producing Hot-Melt Magnetic Tape

A preferable method for producing the hot-melt magnetic tape of the present disclosure is described below. However, the method is not limited to the following production method, and the hot-melt magnetic tape can be produced by various methods.

The present magnetic tape can be obtained, for example, through a step of coating the present magnetic material on a release sheet to form a magnetic layer having a predetermined coating thickness. Examples of the method for coating the magnetic layer include a method for softening or liquefying by heating and forming a layer using a coater. Examples of the coater include a blade coater, a bar coater, a comma coater, a gravure coater, a roll coater, a reverse roll coater, and a die coater. After coating, an organic solvent may be added in order to adjust the viscosity by cooling. When an organic solvent is used, the organic solvent is removed in a warm air drying oven. After forming the magnetic layer, the release sheet may be peeled off, or the release sheet may be laminated until immediately before use.

In addition, in the present magnetic tape, the magnetic layer can be composed of a single layer or multiple layers. In addition, another layer may be laminated. Examples of another layer include a hot-melt non-magnetic layer and a protective layer. The present magnetic tape can be wound into a roll if necessary.

### 5. Cloth-Like Material for Foam Molding

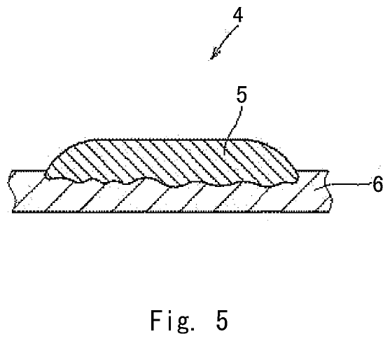

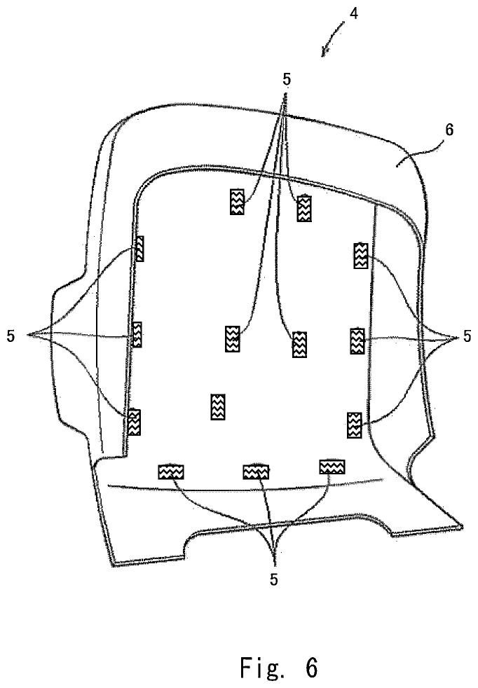

The cloth-like material for foam molding of the present disclosure (hereinafter also referred to as the cloth-like material) is formed by impregnating a hot-melt magnetic material on a part of the surface of nonwoven fabric and fixing it. FIG. 5 shows a schematic partial enlarged view for explaining the state of the cloth-like material in which the hot-melt magnetic material is permeated to be fixed. As shown in the figure, a cloth-like material for foam molding 4 is formed by a hot-melt magnetic material 5 permeated into a part of the surface of nonwoven fabric 6 to be fixed. “Permeated to be fixed” means that the hot-melt magnetic material 5 is heated and melted to be softened, the softened hot-melt magnetic material 5 penetrates into the surface of a specific location of nonwoven fabric 6, and then air-dried or cooled to become a solid state and fixed. As shown in FIG. 5, the hot-melt magnetic material 5 may be impregnated up to the lowest part of the nonwoven fabric, in addition to an aspect in which the hot-melt magnetic material 5 partially penetrates in the thickness direction of the nonwoven fabric. In addition, the present magnetic material may be formed in a convex shape from the surface of the nonwoven fabric (refer to FIG. 5), or the surface of the present magnetic material and the surface of the nonwoven fabric may substantially coincide.

The type of nonwoven fabric is not limited, and an organic fiber is preferably used. There are no particular limitations on the type and thickness of the fiber that constitutes the nonwoven fabric. For example, polyester fibers such as polyethylene terephthalate and polybutylene terephthalate; polyolefin fibers such as polyethylene and polypropylene, which may be copolymers such as homo and random; and polyamide fibers can be used singly, or a combination a plurality of organic fibers can be used. Preferable examples thereof include a polyester fiber, a polypropylene fiber, a polyethylene fiber, and a low melting point polyester fiber having a melting point of 110 to 160° C. In addition, bicomponent fibers of polyester-polyethylene, polyester-low melting point polyester, and polypropylene-polyethylene may be used. In addition, it is preferable that the fiber diameter of the constituent organic fiber is 5 to 30 μm and a fiber (thickness) is about 1 to 33 dtex. The nonwoven fabric is not limited to a single-layer product, and may be a multilayer product obtained by laminating them. The thickness of the nonwoven fabric can be set to, for example, about 0.5 to 10 mm.

### 6. Method for Producing Cloth-Like Material for Foam Molding

A preferable method for producing the cloth-like material for foam molding of the present disclosure is described below. However, the method is not limited to the following production method, and the cloth-like material for foam molding can be produced by various methods.

The preferable method for producing the cloth-like material for foam molding of the present disclosure has: a fixing step of placing the magnetic tape on the surface of the nonwoven fabric, and fixing the magnetic tape at a desired position on the nonwoven fabric by a means for heating; and a step of setting the nonwoven fabric on which the magnetic tape is fixed in a mold and processing and molding into a three-dimensional shape by heating. The heating temperature is preferably 95° C. or more and 120° C. or less.

The shape of the present magnetic tape is not particularly limited, and can be set to various shapes. A suitable example thereof include a long tape extending in the longitudinal direction, with the lateral direction (width direction) being the width of the adherence. For example, using such a long tape can efficiently fix the present magnetic material to the nonwoven fabric as follows. That is, while the above fixing step and the dividing step of dividing the fixed portion of the magnetic tape to the nonwoven fabric from the non-fixed portion of the hot-melt magnetic tape are alternately performed, and the longitudinal direction of the magnetic tape is divided into each of the fixed portion, the present magnetic material can be efficiently fixed at a desired position of the nonwoven fabric.

The fixing step can be performed by setting a raw nonwoven fabric, placing the magnetic tape thereon, melting the magnetic layer of the magnetic tape by a means for heating such as ultrasonic heating, permeating the magnetic layer into the nonwoven fabric, and cooling. In addition, examples of the fixing method include a method in which the release layer side is the upper surface, the magnetic layer is melted from above by a means for heating such as ultrasonic wave or an iron, and is permeated into the nonwoven fabric, and then the release sheet is peeled off.

The present magnetic material has a softening point of more than 100° C., and therefore it is possible to effectively prevent the present magnetic material from oozing out and spreading from the nonwoven fabric when steam heating is performed, for example. Therefore, the productivity can be remarkably improved as compared with the method for three-dimensionally forming the raw nonwoven fabric and then fixing the hot-melt magnetic material to the three-dimensionally formed nonwoven fabric by stamping or the like.

FIG. 6 shows a schematic perspective view of the cloth-like material after three-dimensional molding. According to the present cloth-like material, temporal fixing in a metal mold for foam molding can be easily performed because the present magnetic material is fixed. From the viewpoint of facilitating the setting and taking out of the three-dimensionally molded cloth-like material, it is preferable that the magnet in the metal mold be an electromagnet and that the magnetic force can be switched on and off.

According to the present cloth-like material, the compatibility between the hot-melt magnetic material and the nonwoven fabric can be enhanced by combining the hot-melt magnetic material having a relatively high softening point and specific blending component. In addition, using the present magnetic material having a softening point of more than 100° C. and 150° C. or less can increase the degree of freedom in designing the temperature range when performing three-dimensional processing and molding after fixing the present magnetic material on the raw nonwoven fabric. In addition, if steam heating is performed in a mold for three-dimensional molding of nonwoven fabric, contamination of the mold can be prevented because the magnetic material is less likely to soften. As a result, productivity can be remarkably improved.

### 7. Foam Molded Composite

The present foam molded composite has a structure in which the present cloth-like material and a foam molded material are integrally molded. The foam molded material is obtained by molding a foamed resin. Examples of the foamed resin include a urethane resin, an acrylic resin, a melamine resin, and a polyolefin resin. Of these, a soft urethane resin that is soft and rich in stretchability is suitable.

### 8. Method for Producing Foam Molded Composite

A preferable example of the method for producing the foam molded composite of the present disclosure will be described below. However, the present foam molded composite is not limited to the following method. First, a hot-melt magnetic material is permeated into a part of the surface of nonwoven fabric by using a means for heating to obtain the cloth-like material for foam molding (step a). Subsequently, the cloth-like material for foam molding is temporarily and magnetically fixed to a mold surface of a mold (step b). Magnetic force can be obtained by, for example, placing a magnet in a metal mold. The magnetic force may be turned on or off by an electromagnet.

After the step b, a foam molded body obtained by introducing a foamed resin into the mold and foaming is integrated with the cloth-like material for foam molding to thereby obtain a foam molded composite (step c). For example, a urethane resin can be used as the foamed resin. After the step c, the foam molded composite is removed from the mold (step d). Through these steps, the foam molded composite can be produced.

### 9. Vehicle Seat

A vehicle seat of the present disclosure has the present close-like material. It can also be said to include a foam molded composite. The vehicle seat is provided with, for example, a cushioning material that includes a foam molded composite formed by integrating a foam molded body such as urethane foam with a cloth-like material for foam molding on a frame housing a spring.

### EXAMPLES

The present disclosure will be described based on specific examples in comparison with comparative examples, but the present disclosure is not limited to these. Examples 1, 2, 5, 10, 11, and 17 shall be read as Reference Examples 1, 2, 5, 10, 11, and 17 for the purpose of consistency with the claims.

Raw materials used for a hot-melt magnetic material are shown below.

### α. Ethylene-Vinyl Acetate Copolymer

A-1: Ultrasen 13B53D (manufactured by Tosoh Corporation, ethylene-vinyl acetate copolymer, vinyl acetate content of 42% by mass, MFR: 70 g/10 minutes (190° C.×21.168 N), melting point: <50° C.)
A-2: Ultrasen 722 (manufactured by Tosoh Corporation, ethylene-vinyl acetate copolymer, vinyl acetate content of 28% by mass, MFR: 400 g/10 minutes (190° C.×21.168 N), melting point: 58° C.)

A-3: Ultrasen 720 (manufactured by Tosoh Corporation, ethylene-vinyl acetate copolymer, vinyl acetate content of 28% by mass, MFR: 150 g/10 minutes (190° C.×21.168 N), melting point: 59° C.)

A-4: Ultrasen 751 (manufactured by Tosoh Corporation, ethylene-vinyl acetate copolymer, vinyl acetate content of 28% by mass, MFR: 5.7 g/10 minutes (190° C.×21.168 N), melting point: 65° C.)
A-5: Ultrasen 683 (manufactured by Tosoh Corporation, ethylene-vinyl acetate copolymer, vinyl acetate content of 20% by mass, MFR: 800 g/10 minutes (190° C.×21.168 N), melting point: 74° C.)
A-6: Ultrasen 681 (manufactured by Tosoh Corporation, ethylene-vinyl acetate copolymer, vinyl acetate content of 20% by mass, MFR: 350 g/10 minutes (190° C.×21.168 N), melting point: 72° C.)
A-7: Ultrasen 633 (manufactured by Tosoh Corporation, ethylene-vinyl acetate copolymer, vinyl acetate content of 20% by mass, MFR: 20 g/10 minutes (190° C.×21.168 N), melting point: 78° C.)
A-8: Ultrasen 631 (manufactured by Tosoh Corporation, ethylene-vinyl acetate copolymer, vinyl acetate content of 20% by mass, MFR: 1.5 g/10 minutes (190° C.×21.168 N), melting point: 80° C.)

A-9: Ultrasen 710 (manufactured by Tosoh Corporation, ethylene-vinyl acetate copolymer, vinyl acetate content of 18% by mass, MFR: 18 g/10 minutes (190° C.×21.168 N), melting point: 71° C.)

A-10: Ultrasen 630 (manufactured by Tosoh Corporation, ethylene-vinyl acetate copolymer, vinyl acetate content of 15% by mass, MFR: 1.5 g/10 minutes (190° C.×21.168 N), melting point: 90° C.)
A-11: Ultrasen 625 (manufactured by Tosoh Corporation, ethylene-vinyl acetate copolymer, vinyl acetate content of 15% by mass, MFR: 14 g/10 minutes (190° C.×21.168 N), melting point: 92° C.)
A-12: Ultrasen 526 (manufactured by Tosoh Corporation, ethylene-vinyl acetate copolymer, vinyl acetate content of 7% by mass, MFR: 25 g/10 minutes (190° C.×21.168 N), melting point: 97° C.)

### β. Wax (B)

B-1: Viscol 660-P (polypropylene wax, manufactured by Sanyo Chemical Industries, Ltd., melting point: 145° C.)
B-2: Sasol H1 (Fischer-Tropsch wax, manufactured by Sasol Ltd., South Africa, melting point: 110° C.)
B-3: Polywax 1000 (polyethylene wax, manufactured by NuCera Solutions, USA, melting point: 113° C.)

### γ. Magnetic Powder (C)

C-1: JIP300A-120 (manufactured by JFE Steel Corporation, magnetic powder)
C-2: 70KA (manufactured by Kobe Steel, Ltd., magnetic powder)

### 6. Additive

D-1: Antioxidant: IRGANOX1010 (manufactured by BASF SE)
D-2: Antiblocking agent: Incro Slip C (manufactured by Croda International plc)

The melting point of the ethylene-vinyl acetate copolymer was measured in accordance with JIS K7121. In addition, the melting point of the wax was measured by the DSC method.

### [1] Production of Hot-Melt Magnetic Material

Hot-melt magnetic materials of examples and comparative examples were produced by the following method. That is, the ethylene-vinyl acetate copolymer (A), the wax (B) if necessary, and various additives if necessary were preblended in a Henschel mixer for 5 minutes at the blending ratio shown in Table 1. Then, the preblend was put into the hopper of the extruder and fed into the extruder using a screw feeder. In addition, using another screw feeder, the magnetic powder (C) was put into the extruder so that the blending ratio shown in Table 1 was obtained, kneaded, and extruded under the following conditions to obtain hot-melt magnetic materials of Examples 1 to 20 and Comparative Examples 1 to 5.
(Extrusion condition)
Extruder: Co-rotating twin-screw extruder PMT32-40.5, manufactured by IKG
Corporation
Barrel temperature: 80 to 180° C. (supply port 80° C.), adjusted as appropriate by
MFR or the like (The barrel temperature was adjusted according to the MFR)
Screw rotation speed: 30 to 100 rpm
Feed rate: 5 kg/hr

TABLE 1

| | | Examples | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| EVA | A-1 | 47 | | | | | | | | | | | | |
| (A) | A-2 | | 50 | | | | | | | | | | | |
| | A-3 | | | 50 | | | | | | | | | | |
| | A-4 | | | | 52 | | | | | | | | | |
| | A-5 | | | | | 52 | | | | | | | | |
| | A-6 | | | | | | | | | | | | 50 | |
| | A-7 | | | | | | 52 | | | | | 22 | | |
| | A-8 | | | | | | | 47 | | | | | | |
| | A-9 | | | | | | | | 52 | | | | | 78 |
| | A-10 | | | | | | | | | 48 | | | | |
| | A-11 | | | | | | | | | | 52 | | | |
| | A-12 | | | | | | | | | | | | | |
| Wax (B) | B-1 | 8 | 5 | 5 | | | | | | | | | | |
| | B-2 | | | | 3 | 3 | 3 | 8 | | | | | | |
| | B-3 | | | | | | | | 3 | 7 | 3 | | | |
| Magnetic | C-1 | 45 | 45 | 45 | 45 | 45 | 45 | 45 | 45 | 45 | 45 | 78 | 50 | 22 |
| powder (C) | C-2 | | | | | | | | | | | | | |
| Others | D-1 | 0.1 | 0.1 | 0.1 | 0.1 | 0.1 | 0.1 | 0.1 | 0.1 | 0.1 | 0.1 | 0.1 | 0.1 | 0.1 |
| | D-2 | 0.1 | 0.1 | 0.1 | 0.1 | 0.1 | 0.1 | 0.1 | 0.1 | 0.1 | 0.1 | 0.1 | 0.1 | 0.1 |
| Total content of | | 100 | 100 | 100 | 100 | 100 | 100 | 100 | 100 | 100 | 100 | 100 | 100 | 100 |
| (A) + (B) + (C) | | | | | | | | | | | | | | |
| | | | Examples | | | | | | | Comparative Examples | | | | |
| | | | 14 | 15 | 16 | 17 | 18 | 19 | 20 | 1 | 2 | 3 | 4 | 5 |
| | EVA | A-1 | | | | 3 | | | | | | | | |
| | (A) | A-2 | | | | | | | 17 | | 45 | | | |
| | | A-3 | | | | | | | | | | 30 | | |
| | | A-4 | | 43 | | | | | | | | | | |
| | | A-5 | | | | | | | | | | | | |
| | | A-6 | | | 78 | 49 | | | | | | | | 12 |
| | | A-7 | 22 | | | | | | | | | | 92 | |
| | | A-8 | | | | | 17 | | | | | | | |
| | | A-9 | | | | | | 22 | | | | | | |
| | | A-10 | | | | | | | 5 | | | | | |
| | | A-11 | | | | | 25 | | | | | | | |
| | | A-12 | | | | | | 10 | | 52 | | | | |
| | Wax (B) | B-1 | | | | | | | | | | | | |
| | | B-2 | 7 | 7 | 7 | 3 | 3 | 3 | 3 | 3 | 10 | 30 | 3 | 3 |
| | | B-3 | | | | | | | | | | | | |
| | Magnetic | C-1 | 71 | | 15 | 45 | 55 | 65 | 75 | 15 | 45 | 40 | 5 | 85 |
| | powder (C) | C-2 | | 50 | | | | | | | | | | |
| | Others | D-1 | 0.1 | 0.1 | 0.1 | 0.1 | 0.1 | 0.1 | 0.1 | 0.1 | 0.1 | 0.1 | 0.1 | 0.1 |
| | | D-2 | 0.1 | 0.1 | 0.1 | 0.1 | 0.1 | 0.1 | 0.1 | 0.1 | 0.1 | 0.1 | 0.1 | 0.1 |

| | | | | | | | | | | | | |
|---|---|---|---|---|---|---|---|---|---|---|---|---|
| Total content of | 100 | 100 | 100 | 100 | 100 | 100 | 100 | 100 | 100 | 100 | 100 | 100 |
| (A) + (B) + (C) | | | | | | | | | | | | |

The softening point, MFR, saturation magnetization density, and thickness of the magnetic layer of the magnetic tape of each example and comparative example were measured by the following method. The measurement results are shown in Table 2.

### <Ring and Ball Softening Point>

The softening point of the hot-melt magnetic material of each example and comparative example was determined in accordance with JIS K-6863 Testing methods for the softening point of hot melt adhesives. Glycerin was used as the solvent.

### <MFR>

The MFR of the hot-melt magnetic material of each example and comparative example was measured under conditions of 190° C. and 21.168 N in accordance with JIS K7210.

### <Saturation Magnetization Density>

The saturation magnetization of the hot-melt magnetic material was measured by using a vibrating sample magnetometer (VSM) BHV-50 (manufactured by Riken Denshi Co., Ltd.).

### [2] Preparation of Hot-Melt Magnetic Tape

A hot-melt magnetic layer was formed on a release-treated layer of a PET film/release-treated layer (silicone treatment) with a T-die by using the hot-melt magnetic materials of each example and comparative example, and a sheet of a PET film/release-treated layer/hot-melt magnetic layer was obtained. Each obtained sheet was cut into a long shape with a width of 13 mm by using a cutter to obtain a hot-melt magnetic tape according to each example and comparative example.

Extrusion laminator: 400M/M test EXT laminator, manufactured by Musashino Kikai Co., Ltd.

Resin temperature directly below die: 80 to 280° C. (adjusted by MFR and the like)

Processing speed: 1 to 30 m/min (the thickness of the magnetic layer sheet was controlled by the processing speed and the like)

T-die width: 400 mm

Temperature on surface of cooling roll: 20 to 25° C.

### <Thickness of Magnetic Layer>

The thickness of the hot-melt magnetic layer of example and the like was determined by using a J&T measuring instrument, a digital thickness gauge meter (purchased from OZAKI MFG. Co., Ltd.).

TABLE 2

| | | | | | Hot-melt |
|---|---|---|---|---|---|
| | | Physical properties of hot-melt | | | magnetic |
| | | magnetic material | | | tape |
| | | | | Saturation | Thickness of |
| | | Softening | | magnetization | magnetic |
| | | point | MFR g/10 | density | layer |
| | | (° C.) | minutes | (emu/cm³) | (μm) |
| Examples | 1 | 103 | 151 | 200 | 200 |
| | 2 | 101 | 509 | 200 | 300 |
| | 3 | 106 | 231 | 210 | 400 |
| | 4 | 115 | 8 | 220 | 300 |
| | 5 | 102 | 964 | 210 | 300 |
| | 6 | 108 | 29 | 200 | 500 |
| | 7 | 111 | 20 | 210 | 400 |
| | 8 | 109 | 27 | 200 | 500 |
| | 9 | 138 | 21 | 210 | 300 |
| | 10 | 145 | 21 | 210 | 500 |
| | 11 | 103 | 19 | 360 | 150 |
| | 12 | 106 | 368 | 230 | 300 |
| | 13 | 121 | 17 | 100 | 700 |
| | 14 | 110 | 94 | 320 | 200 |
| | 15 | 136 | 21 | 220 | 600 |
| | 16 | 109 | 484 | 60 | 1000 |
| | 17 | 103 | 366 | 210 | 300 |
| | 18 | 140 | 10 | 260 | 400 |
| | 19 | 128 | 32 | 300 | 400 |
| | 20 | 105 | 190 | 350 | 500 |
| Comparative | 1 | 160 | 33 | 210 | 300 |
| Examples | 2 | 82 | 754 | 200 | 200 |
| | 3 | 72 | 1164 | 170 | 400 |
| | 4 | 131 | 26 | 18 | 200 |
| | 5 | 110 | 650 | 400 | 250 |

### [3] Preparation of Cloth-Like Material for Foam Molding

As a nonwoven fabric, Tafnel manufactured by Mitsui Chemicals Inc. was used (a single-layer dry-laid nonwoven fabric having a basis weight of 140 g/m² made by a carding method, and as a raw material, a fiber mixed with 70% by mass of polyester staple fiber (fineness 2.2 dtex) and 30% by mass of polyethylene-polypropylene bicomponent staple fiber (fineness 2.2 dtex) was used).

The hot-melt magnetic tape of each example and comparative example having a thickness shown in Table 2 was placed on the nonwoven fabric (5 cm×10 cm) before the three-dimensional processing described above, and heated for 1 second with an ultrasonic sealing machine (ultrasonic transmitter SH-3510 (500 W specification) and an ultrasonic vibrator SF-8500RR (using 22 KHz), manufactured by Sonotec Co.) to obtain the cloth-like material for foam molding according to each example and comparative example.

### <Permeation Evaluation>

A hot-melt magnetic material tape with a width of 13 mm was placed on the nonwoven fabric described above, and an area of 15 mm×15 mm was heated for 1 second with an ultrasonic sealing machine (ultrasonic transmitter SH-3510 (manufactured by Sonotec Co., 500 W specification, using 22 KHz) and an ultrasonic vibrator SF-8500RR (manufactured by Sonotec Co.)) to permeate the hot-melt magnetic material into the organic fiber nonwoven fabric. In order to measure the shear strength, the hot-melt magnetic tape was reinforced with gummed tape, and the shear strength of the nonwoven fabric and the magnetic tape was measured with a tensile tester. The permeation of the hot-melt magnetic material into the nonwoven fabric was evaluated according to the following criteria.

5: The magnetic tape was broken or the shear strength was 20 N or more.
4: The nonwoven fabric was broken and the shear strength was 10 N or more and less than 20 N.
3: The nonwoven fabric was broken and the shear strength was 5 N or more and less than 10 N.
2: The nonwoven fabric was broken and the shear strength was 1 N or more and less than 5 N.
1: The hot-melt magnetic material was not permeated into the nonwoven fabric, or the shear strength was less than 1 N.
2 to 5 were considered pass, and 1 was considered unsuccessful.

### <Separability Evaluation>

A long hot-melt magnetic material tape with a width of 13 mm was placed on the nonwoven fabric described above, and an area of 15 mm×15 mm was heated for 1 second with an ultrasonic sealing machine (ultrasonic transmitter SH-3510 (manufactured by Sonotec Co., 500 W specification), an ultrasonic vibrator SF-8500RR (using 22 KHz)). Thereafter, the non-fixed portion of the magnetic tape that had not been ultrasonically treated was pulled, and the separability at the boundary between the ultrasonically treated area (fixed portion to the nonwoven fabric) and the ultrasonically untreated tape (non-fixed portion to the nonwoven fabric) was evaluated according to the following criteria.

5: Separation was possible without stringing.
4: Separation was possible, but a thread with a stringing length of less than 3 mm was generated.
3: Separation was possible, but a thread with a stringing length of 3 mm or more and 5 mm or less was generated.
2: Separation was possible, but a thread with a stringing length of 5 mm or more was generated.
1: Separation was impossible.
2 to 5 were considered pass, and 1 was considered unsuccessful.

In Comparative Example 1, the hot-melt magnetic material was not permeated into the nonwoven fabric in the meltability test, and a cloth-like material for foam molding could not be prepared. Hereinafter, the case where the cloth-like material for foam molding could not be prepared is indicated as ‘-’ in the table.

### <Adsorption of Cloth-Like Material for Foam Molding to Magnet>

A weight was attached to the cloth-like material for foam molding according to each example and comparative example and a permanent magnet (2800 G) with a mass of 2.5 g and a diameter of 10 mm was lifted to evaluate adsorption of the hot-melt magnetic tape to the magnet according to the following criteria.

5: The material did not fall with a weight of 20 g.
4: The material fell when a weight of 20 g was attached, but did not fall when a weight of 15 g was attached.
3: The material fell when weights of 20 and 15 g were attached, but did not fall when a weight of 10 g was attached.

2: The material fell when weights of 10, 15, and 20 g were attached, but did not fall when a weight of 5 g was attached.

1: The material fell when any weight of 5, 10, 15 or 20 g was attached.
2 to 5 were considered pass, and 1 was considered unsuccessful.

In Comparative Examples 1 and 5, the hot-melt magnetic material was not permeated into the nonwoven fabric in the meltability test, and the cloth-like material for foam molding that was fixed with the hot-melt magnetic material could not be prepared.

### <Adhesion Evaluation>

There was prepared a cloth-like material for foam molding in which a hot-melt magnetic material tape was permeated into nonwoven fabric made of an organic fiber. Then, the cloth-like material for foam molding was set in the mold composed of a polycarbonate sheet (hereinafter also referred to as “PC”) and a 1 cm-diameter round magnet (nickel-plated neodymium magnet, manufactured by Daiso-sangyo) embedded and exposed on the surface. Then, the cloth-like material for foam molding was three-dimensionally molded by steam heating. The molded cloth-like material for foam molding was left to cool for 10 seconds. Thereafter, the cloth-like material for foam molding was peeled off. Then, whether or not the hot-melt magnetic material according to each example and comparative example adhered to the PC and the magnet was evaluated according to the following criteria. The surface temperature of the magnet was 100° C., and the surface temperature of the PC was 90° C.

5: The hot-melt magnetic material was not adhered at all.
4: The hot-melt magnetic material was adhered in dots to the PC (or the magnet).
3: The hot-melt magnetic material was adhered in an area of less than 10% to the PC (or the magnet).
2: The hot-melt magnetic material was adhered in an area of 10% or more and 30% or less to the PC (or the magnet).
1: The hot-melt magnetic material was adhered in an area of 30% or more to the PC (or the magnet).
2 to 5 were considered pass, and 1 was considered unsuccessful.

In Comparative Examples 1 and 5, the hot-melt magnetic material was not permeated into or separated from the nonwoven fabric in the meltability test or the separability test, and thus the cloth-like material for foam molding that was fixed with the hot-melt magnetic material could not be prepared.

### <Mold Followability>

The nonwoven fabric to which the hot-melt magnetic material was fixed was set on the PC being the mold having a bent portion, and the nonwoven fabric was molded by steam heating. As the bending portion of the PC, the test was performed in four regions with bending angles of 157.5°, 135°, 112.5°, and 90°. The followability of the cloth-like material for foam molding containing the hot-melt magnetic material to the PC containing the bent portion was evaluated according to the following criteria.

5: The cloth-like material for foam molding followed PC with bending angles of 157.5°, 135°, 112.5°, and 90°, and no lifting was visually observed.
4: The cloth-like material for foam molding followed PC with bending angles of 157.5°, 135°, and 112.5°, and no lifting was visually observed. However, lifting was observed in PC of 90°.
3: The cloth-like material for foam molding followed PC with bending angles of 157.5° and 135°, and no lifting was visually observed. However, lifting was observed in PC of 112.5° and 90°.
2: The cloth-like material for foam molding followed PC with bending angles of 157.5°, and no lifting was visually observed. However, lifting was observed in PC of 135°, 112.5°, and 90°.
1: Lifting was observed in PC with a bending angle of 157.5°.
2 to 5 were considered pass, and 1 was considered unsuccessful.

TABLE 3

| | | | | Adsorption | Adhesion to | Adhesion to | Mold |
|---|---|---|---|---|---|---|---|
| | | Permeation | Separability | to magnet | magnet | resin | followability |
| Examples | 1 | 3 | 3 | 3 | 4 | 2 | 4 |
| | 2 | 5 | 5 | 3 | 3 | 3 | 3 |
| | 3 | 5 | 5 | 4 | 5 | 5 | 3 |
| | 4 | 3 | 5 | 4 | 5 | 5 | 5 |
| | 5 | 5 | 5 | 4 | 3 | 3 | 2 |
| | 6 | 5 | 5 | 5 | 5 | 5 | 5 |
| | 7 | 5 | 5 | 4 | 5 | 5 | 4 |
| | 8 | 5 | 5 | 5 | 5 | 5 | 5 |
| | 9 | 3 | 5 | 4 | 5 | 5 | 4 |
| | 10 | 3 | 2 | 5 | 5 | 5 | 5 |
| | 11 | 5 | 5 | 5 | 3 | 3 | 5 |
| | 12 | 5 | 5 | 4 | 4 | 4 | 3 |
| | 13 | 5 | 3 | 2 | 5 | 5 | 5 |
| | 14 | 5 | 5 | 5 | 5 | 5 | 5 |
| | 15 | 5 | 5 | 5 | 5 | 5 | 5 |
| | 16 | 5 | 4 | 2 | 5 | 5 | 3 |
| | 17 | 5 | 5 | 4 | 4 | 4 | 3 |
| | 18 | 5 | 3 | 5 | 5 | 5 | 5 |
| | 19 | 5 | 4 | 5 | 5 | 5 | 5 |
| | 20 | 5 | 5 | 5 | 5 | 5 | 4 |
| Comparative | 1 | 1 | — | — | — | — | — |
| Examples | 2 | 5 | 5 | 3 | 1 | 1 | 1 |
| | 3 | 5 | 5 | 4 | 1 | 1 | 5 |
| | 4 | 5 | 5 | 1 | 5 | 5 | 5 |
| | 5 | 5 | 1 | — | — | — | — |

Comparative Example 1, in which the ring and ball softening point exceeded 150° C., had the problems of separability, meltability, and mold followability. Comparative Examples 2 and 3, in which the content of the wax (B) exceeded 8% by mass, had the problem of adhesion. Comparative Example 4, in which the content of the magnetic powder (C) was less than 15% by mass, was excellent in separability and meltability, but had the problem of adsorption to the magnet. In contrast, Comparative Example 5, in which the content of the magnetic powder (C) exceeded 80% by mass, was excellent in meltability and the like, but had the problem of separability. Whereas, in Examples 1 to 20 using the present magnetic material, it was confirmed that they were excellent in adsorption to the magnet, separability, meltability, adherence, and mold followability.

What is claimed is:

1. A hot-melt magnetic tape for a foam molded body, the tape comprising a magnetic layer formed from a hot-melt magnetic material, wherein
(i) the hot-melt magnetic material has a ring and ball softening point of 105° C. or more and 140° C. or less, and
(ii) the hot-melt magnetic material includes: a thermoplastic resin containing an ethylene-vinyl acetate copolymer (A); and a magnetic powder (C), and optionally further includes a wax (B), and
wherein 20 to 80% by mass of the component (A), 0 to 8% by mass of the component (B), and 15 to 80% by mass of the component (C) are contained in 100% by mass in total of the component (A), component (B), and component (C), and a structural unit derived from a vinyl acetate monomer for the ethylene-vinyl acetate copolymer (A) accounts for 15 to 30% by mass.

2. The hot-melt magnetic tape according to claim 1, wherein a saturation magnetization density of the hot-melt magnetic material is 20 to 400 emu/cm³.

3. The hot-melt magnetic tape according to claim 1, further comprising use of the hot-melt magnetic tape for an application for obtaining a cloth-like material for foam molding, containing the hot melt magnetic material fixed therein by placing the hot-melt magnetic tape extending in a longitudinal direction on nonwoven fabric, impregnating and fixing the hot-melt magnetic material in a part of a surface of the nonwoven fabric through heating, and dividing the part of the nonwoven fabric in which the hot-melt magnetic material has been fixed from the part thereof in which the hot-melt magnetic material has not been fixed.

4. A cloth-like material for foam molding, formed by impregnating and fixing a hot-melt magnetic material on a part of a surface of a nonwoven fabric, wherein
(i) the hot-melt magnetic material has a ring and ball softening point of 105° C. or more and 140° C. or less, and
(ii) the hot-melt magnetic material includes: a thermoplastic resin containing an ethylene-vinyl acetate copolymer (A); and a magnetic powder (C), and optionally further includes a wax (B), wherein 20 to 80% by mass of the component (A), 0 to 8% by mass of the component (B), and 15 to 80% by mass of the component (C) are contained in 100% by mass in total of the component (A), component (B), and component (C), and a structural unit derived from a vinyl acetate monomer for the ethylene-vinyl acetate copolymer (A) accounts for 15 to 30% by mass.

5. The cloth-like material for foam molding according to claim 4, wherein a melt flow rate of the hot-melt magnetic material at 190° C. and 21.168 N is 5 to 1000 g/10 minutes.

6. A method for producing a cloth-like material for foam molding, the method comprising:
a fixing step of placing a hot-melt magnetic tape extending in a longitudinal direction on a surface of nonwoven fabric, and fixing the hot-melt magnetic tape in a desired part of the nonwoven fabric through heating;
a dividing step of dividing a fixed portion of the hot-melt magnetic tape to the nonwoven fabric by the fixing step and a non-fixed portion of the hot-melt magnetic tape; and
a step of setting the nonwoven fabric in which the hot-melt magnetic tape has been fixed in a mold, and processing and molding the nonwoven fabric three-dimensionally through heating, wherein
the hot-melt magnetic tape includes a magnetic layer formed from a hot-melt magnetic material, and wherein
(i) the hot-melt magnetic material has a ring and ball softening point of 100° C. or higher and 150° C. or lower, and
(ii) the hot-melt magnetic material contains: a thermoplastic resin containing an ethylene-vinyl acetate copolymer (A); and a magnetic powder (C), and optionally further contains a wax (B), and also contains 20 to 80% by mass of the component (A), 0 to 8% by mass of the component (B), and 15 to 80% by mass of the component (C) in total of 100% by mass of the component (A), component (B), and component (C), and
the fixing step and the dividing step are performed alternately to fix a hot-melt magnetic material at a desired position of the nonwoven fabric while dividing the hot-melt magnetic tape into each of the fixed portion.

7. The method for producing a cloth-like material for foam molding according to claim 6, wherein the hot-melt magnetic material has a ring and ball softening point of 105° C. or more and 140° C. or less, and
a structural unit derived from a vinyl acetate monomer for the ethylene-vinyl acetate copolymer (A) accounts for 15 to 30% by mass.

8. The method for producing a cloth-like material for foam molding according to claim 6, wherein the means for heating is ultrasonic heating.

9. A method for producing a foam molded composite, the method comprising:
a step a of permeating a hot-melt magnetic material into a part of a surface of a nonwoven fabric by using a means for heating to obtain the cloth-like material for foam molding according to claim 4;
a step b of temporarily and magnetically fixing the cloth-like material for foam molding to a mold surface of a mold;
a step c of integrating, after the step b, a foam molded body obtained by introducing a foamed resin into the mold and foaming, with the cloth-like material for foam molding to thereby obtain a foam molded composite; and
a step d of removing, after step c, the foam molded composite from the mold.
